(19) United States
(12) Patent Application Publication
(10) Pub. No.: US 2026/0067179 A1
(43) Pub. Date: Mar. 5, 2026

(54) GENERATING COMPOSITE DATA VALUES FROM HETEROGENEOUS DATABASE SOURCES

(71) Applicant: MASTERCARD INTERNATIONAL INCORPORATED, PURCHASE, NY (US)

(72) Inventors: Stalin Petronius, O'Fallon, MO (US); Amit Vasant Shinde, Pune (IN); Bejoy Lucy Mathew, Dardenne Prairie, MO (US); Sushant Prakash Pailwan, Pune (IN)

(21) Appl. No.: 19/313,834

(22) Filed: Aug. 28, 2025

Related U.S. Application Data
(60) Provisional application No. 63/688,854, filed on Aug. 29, 2024.

(51) Int. Cl. H04L 41/22; H04L 41/16; H04L 43/045; H04L 67/75

(52) U.S. Cl. CPC H04L 41/22; H04L 41/16; H04L 43/045; H04L 67/75

(57) ABSTRACT

Examples provide a system, method, and computer storage medium for generating composite data values from heterogeneous database sources and rendering them in a user interface display. The system includes a processor and a computer-readable medium storing instructions. The instructions, upon execution, enable the system to automatically receive operational performance data from multiple database sources, identify a plurality of data correlation patterns within the operational performance data, and calculate weighting coefficients for the plurality of data correlation patterns using a computational analysis module. The composite data value is calculated based on the weighted data correlation patterns and rendered as a graphical interface element in a user interface display. The graphical interface element is automatically positioned at a calculated location within the user interface display based on a numerical magnitude of the composite data value.

### BACKGROUND

Computing systems generate vast amounts of operational data from multiple sources including individual user sessions, device performance metrics, application usage statistics, and service interaction logs. Traditional data storage and retrieval systems struggle to efficiently organize and structure this heterogeneous data due to varying data formats, inconsistent collection intervals, and disparate storage locations across distributed computing environments.

Conventional database management systems lack the structural capability to correlate related data points from these diverse sources into unified data records. The absence of integrated data structures results in fragmented information storage where related operational metrics remain isolated in separate database tables or files. This fragmentation requires complex query operations and multiple database joins to retrieve comprehensive information about any single operational context, leading to inefficient system resource utilization and increased computational overhead.

Current approaches require manual data reconciliation processes to correlate information from different sources, consuming substantial processing time and system memory. The lack of standardized data structures for multi-source operational data creates additional computational complexity when attempting to establish relationships between related data points across the distributed storage system.

### SUMMARY

In accordance with embodiments, a system is provided for calculating a composite data value representing aggregated system. The system comprises a processor and a computer-readable medium storing instructions that are operative upon execution by the processor to automatically receive operational performance data, identify features in the data, and assign weights to the features based on each feature's impact on a composite data value. The composite data value is calculated based on the weighted features and is presented as an icon in a user interface. The icon of the composite data value is automatically moved to a position in the user interface based on a magnitude of the composite data value.

In accordance with other embodiments, a computerized method is provided for calculating a composite data value. The method involves automatically receiving operational performance data, identifying features in the data, and assigning weights to the features based on each feature's impact on a composite data value. The composite data value is calculated based on the weighted features and is presented as an icon in a user interface. The icon of the composite data value is automatically moved to a position in the user interface based on a magnitude of the composite data value.

In yet other embodiments, a computer storage medium is provided having computer-executable instructions that, upon execution by a processor, cause the processor to automatically receive operational performance data, identify features in the data, and assign weights to the features based on each feature's impact on a composite data value. The composite data value is calculated based on the weighted features and is presented as an icon in a user interface. The icon of the composite data value is automatically moved to a position in the user interface based on a magnitude of the composite data value.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a block diagram illustrating an example system for automatically generating and presenting a digital composite data value on a user interface.

FIG. 2 is a block diagram illustrating another example system for automatically generating and presenting a digital composite data value on a user interface.

FIG. 3 is a flow chart illustrating an example operation of a computing device to generate and present a digital composite data value on a user interface.

FIG. 4 is a flow chart illustrating an example operation of a computing device to calculate a digital composite data value.

FIG. 5 is a flow chart illustrating an example operation of a computing device to determine weights to features using machine learning.

FIG. 6 is a block diagram illustrating an example system to assign weights to features.

FIG. 7 is an example user interface displaying a digital composite data value icon in a user interface.

FIG. 8 is an example user interface displaying components of a digital composite data value in a user interface.

FIG. 9 illustrates a block diagram of an example computing apparatus.

Corresponding reference characters indicate corresponding parts throughout the drawings. Any of the figures may be combined into a single example or implementation.

### DETAILED DESCRIPTION

A more detailed understanding can be obtained from the following description, presented by way of example, in conjunction with the accompanying drawings. The entities, connections, arrangements, and the like that are depicted in, and in connection with the various figures, are presented by way of example and not by way of limitation. As such, any and all statements or other indications as to what a particular figure depicts, what a particular element or entity in a particular figure is or has, and any and all similar statements, that can in isolation and out of context be read as absolute and therefore limiting, can only properly be read as being constructively preceded by a clause such as “In at least some examples, . . . ” For brevity and clarity of presentation, this implied leading clause is not repeated ad nauseum.

Computing systems collect operational data through multiple automated data gathering processes executing on distributed computing devices. Background processes continuously transmit device performance metrics to centralized database systems for storage and retrieval operations. Network monitoring applications similarly collect and store performance data points in structured database tables. However, these disparate data collection mechanisms result in fragmented data storage across multiple database structures, where individual data points lack sufficient relational context to generate meaningful composite data values. Current database architectures fail to provide adequate data correlation mechanisms to establish relationships between related performance metrics stored in separate data structures. Additionally, manual data input processes through form-based interfaces introduce inconsistent data formatting and create additional database storage overhead due to unstructured text entries and variable response formats.

Existing user interface systems present significant computational inefficiencies when displaying numerical data values to users. Current interface designs require users to perform multiple data interpretation steps when processing numerical information, particularly when numerical values are presented alongside text-based descriptive content. This cognitive processing requirement results in extended user interaction periods with the computing device interface, generating increased system resource consumption through repeated data retrieval operations and sustained memory allocation for interface rendering. The prolonged user interaction sessions create additional computational processing demands on the computing system, consuming excess CPU cycles, memory resources, and network bandwidth for maintaining active interface connections and processing repeated user input operations.

In contrast, the present disclosure provides a data correlation system that generates composite data values representing aggregated performance metrics across multiple data sources within a computing environment (referred to as a digital experience score in some examples). The system processes heterogeneous operational data through a data processing engine configured to identify data patterns and relationships within stored datasets that affect overall system performance metrics. The operational data encompasses at least application performance data stored in application database tables, device performance data stored in device database tables, and network performance data stored in network database tables. A computational analysis framework processes the identified data patterns to determine weighting coefficients for each data relationship based on correlation strength between related data points. The data processing engine applies the weighting coefficients to the identified data patterns and calculates a unified composite data value representing the aggregated system performance state. The composite data value is then rendered as a user interface (UI) element in a user interface display and positioned at a corresponding location on a visual indicator interface based on the numerical magnitude of the calculated composite value.

The computing device operates in an unconventional manner by calculating and presenting a composite data value in a UI automatically. Individuals are not required to complete evaluation forms to calculate the composite data value. In this manner, the computing device is used in an unconventional way, and allows for the automatic generation of digital experience scores without requiring individuals to fill out any forms, thereby reducing the computational processing load, memory, energy, and/or bandwidth consumption on the device that would otherwise occur from individuals completing evaluation forms. This improves the functioning of the underlying device.

Further, aspects of the disclosure improve the usability of the underlying device at least by automatically moving an icon representing the composite data value to a position on a dashboard meter based on the magnitude of the composite data value. User interaction performance is also improved via additionally presenting icons representing the components of the composite data value on corresponding dashboard meters as described herein. This improves the human-machine interaction.

The disclosure constitutes a technological improvement to computer database systems and user interface rendering. The disclosure addresses specific technical problems inherent in conventional database architectures, such as: the inability to efficiently correlate heterogeneous operational data stored across multiple database structures, and the computational inefficiencies of existing user interface systems when rendering numerical data with contextual information. The disclosure provides practical, technological solutions including (1) a specialized data processing engine that implements data correlation algorithms to establish relationships between disparate data points stored in separate database tables, thereby reducing query complexity and computational overhead, and (2) an improved UI rendering system that optimizes graphical element positioning based on numerical magnitude calculations, reducing CPU processing cycles and memory allocation requirements during interface display operations. At least these example technical improvements result in measurable enhancements to computer system performance, including reduced database query execution time, decreased memory consumption during data retrieval operations, and improved computational efficiency in UI rendering processes. The disclosure transforms the computer itself by providing a more efficient database correlation mechanism and a computationally optimized UI system, rather than merely using conventional computers to perform abstract data analysis or business intelligence functions.

As used in this disclosure, the term “persona” refers to the individual/user, device, application, or service to which the operational performance data and calculated composite data value pertains. The persona could also be the same user that interacts with the user interface described herein but does not have to be. When the persona is an individual, the term “persona digital experience” refers to the digital experience of the user. When the persona is a device, application, or service, the term “persona digital experience” refers to the digital experience of individuals interacting with that persona. The terms “composite data value,” “final composite data value,” “digital experience score,” “final experience score,” and “experience score” are used interchangeably. Additionally, the terms “features” and “relevant features” are used interchangeably.

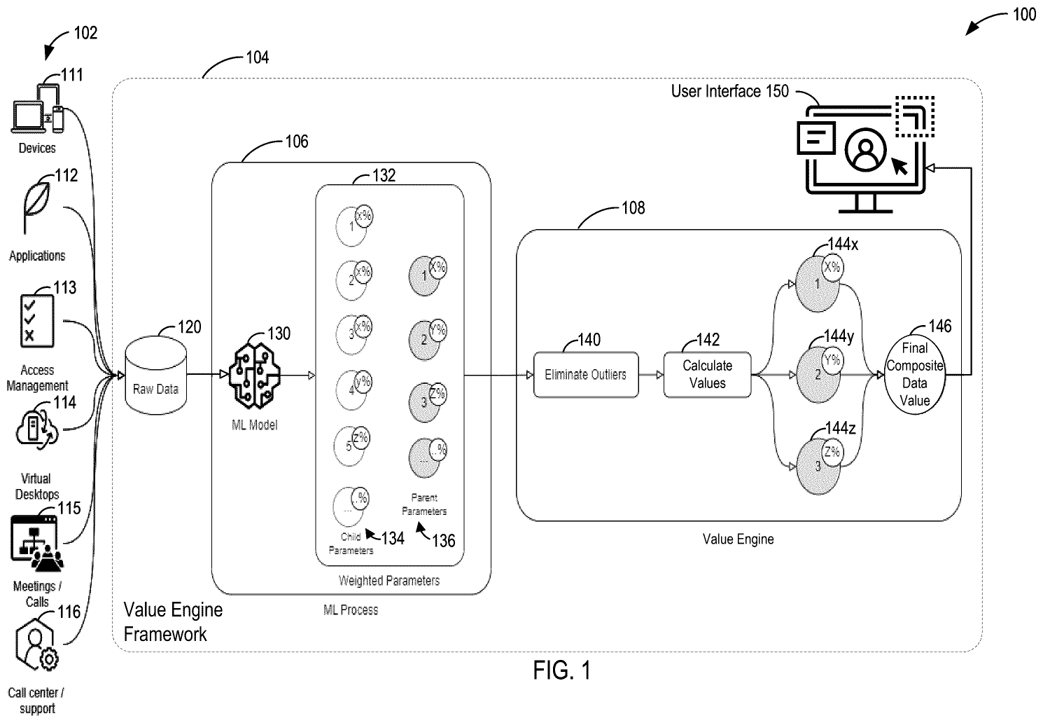

Referring to FIG. 1, a system 100 for generating and presenting a composite data value in a UI is shown. The system 100 comprises various data sources 102 and a value engine framework 104. The value engine framework 104 is a data processing engine that comprises operational performance data 120, a ML process 106, a value engine 108, and a UI 150. Various types of operational performance (i.e. experience) data are collected as raw operational performance data 120. In some versions, the operational performance data for a particular persona. The collected data is then prepared for analysis, features are identified, weights are assigned to these features, and values are calculated and aggregated to arrive at the final composite data value. The final composite data value is then visually presented in the UI 150.

The data collected from various data sources 102 is raw operational performance data 120 and serves as the foundation for the system's subsequent analysis. This data includes information from various sources such as application usage, device performance, and network connectivity. Depending on the implementation, the various data sources 102 comprise device data 111, applications data 112, access management data 113, virtual desktops data 114, network data 115, and/or support data 116 a among others. The various data sources 102 include a variety of systems of record, such as customer relationship management (CRM) systems, human capital management (HCM) systems, finance, operational efficiency tools, and information technology service management (ITSM) systems. It is gathered automatically, ensuring efficiency and non-reliance on direct persona input. The raw operational performance data 120 is scrubbed so that it can be used for machine learning.

A machine-learning (ML) process 106 is used to identify features within the operational performance data 120 that are relevant to calculating a composite data value representing a system's performance and to assign a weight to those features. A ML model 130 identifies relevant features in the operational performance data 120 that ultimately impact the composite data value. The identification of relevant features requires the system to analyze persona interactions with applications, devices, and networks, identifying specific behaviors or events that correlate with the persona's experience. For instance, the system might recognize frequent application crashes or slow network speeds as features that negatively impact the composite data value, while consistent application performance and reliable network connectivity might be recognized as features that contribute positively to the composite data value.

The ML process 106 then analyzes the data to determine the impact of each identified feature. The analysis involves statistical models and AI/ML techniques that assign weights 132 to each feature based on their impact on the composite data value. The relevant features are organized by categories corresponding to the originating data type, such as network data, device data, and application data. This involves a ML model in some implementations, such as ML model 130, that assigns weights to features within the operational performance data. The model assigns weights based on the relative impact of each feature to the composite data value. To determine the weights, the ML model is trained with a dataset of various operational performance data with corresponding data values. The use of a ML model eliminates any human errors or bias from the composite data value calculation, improving effectiveness and fairness.

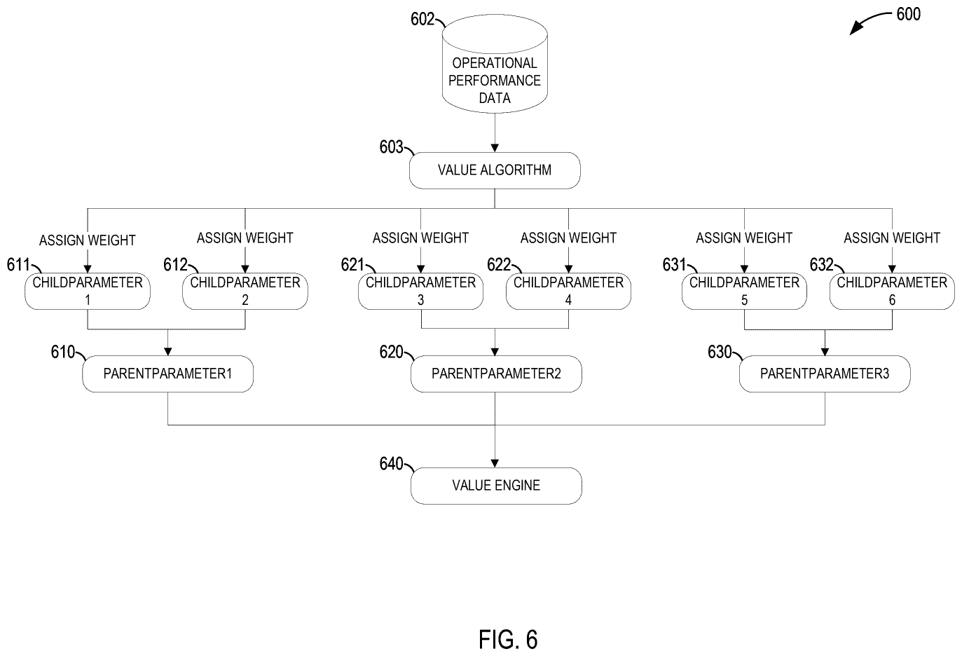

In some examples, each identified feature is a child parameter 134 and each category is a parent parameter 136. Each child parameter 134 correspond to a respective parent parameter 136. One or more child parameters 134 can correspond to a single parent parameter 136. In some implementations, the parent parameters are assigned weights based on their impact to the final composite data value. In at least one implementation, the child parameters 134 are then assigned weights based on their relative impact to their corresponding parent parameter 136. In other words, each child parameter 134 is assigned a percent value representing its impact on the parent parameter score, i.e., a digital experience category score. These include an application score, a device score, and a network score. In another implementation, each child parameter 134 is instead assigned a value representing its impact on the final composite data value. Here, the parent parameter values are sum of the corresponding child parameters. This approach means that the categories represent the combined importance of their respective features. An alternative description of the scoring process is shown in system 600 of FIG. 6.

A value engine 108 computes the composite data value, which is derived from the weighted relevant features of at least the application, device, and network scores. The value engine is a software component tasked with processing the weighted relevant features to determine the final composite data value. The value engine 108 eliminates outlier weights 140 from the composite data value computation. This removes values that are considered statistically unlikely and that would otherwise skew the calculation to a significant degree.

The value engine 108 calculates the various data values 142 according to the assigned weight of each. Depending on the implementation, the value engine 108 calculates both category scores and relevant feature scores. The final composite data value 146 is calculated by aggregating the various category scores 144x-z. In some implementations, the various category scores have different impacts on the final composite data value. For example, an application score 144x represents X % of the final score, a device score 144y represents Y % of the final score, and a network score 144z represents Z % of the final score. The percentages total to 100%. In other implementations, each category has the same impact on the final score. In either type of implementation, the final composite data value 146 represents the combined impact of all relevant features on the system's performance.

The final composite data value 146 is presented within a user interface (UI) 150. The UI 150 then displays the composite data value as a graphical element, such as an icon, and positions it on a dashboard meter to visually indicate the value's magnitude. The UI 150 is responsible for displaying the icon in a manner that conveys the magnitude of the composite data value. The appearance, color, or position of the icon within the UI 150 may vary to reflect different types or categories of values. The placement of the icon on a dashboard meter is designed to provide users with immediate feedback regarding the quality of the system's performance, allowing for quick identification of areas that may need attention. The visualization of the composite data value through an icon in the UI 150 serves to communicate complex data in a simplified manner. It is designed to facilitate understanding and communication of the value's significance without requiring in-depth analysis by the user. This visual representation contributes to the case of interaction with the system.

In some implementations, the system 100 performs proactive actions to improve the system's performance based on the descriptive and diagnostic insights gained from calculating the final composite data value 146. In at least one implementation, the system 100 sends an alert to the system's manager (e.g., by generating an automated e-mail) if the system's composite data value drops below a certain threshold. In another implementation, if a category or relevant feature value drops below a certain threshold, the system 100 stores the category or relevant feature value and metadata to a corresponding category or relevant feature datastore respectively (not shown). If the datastore receives a threshold number of relevant feature values within a given time period, then the system 100 automatically alerts a team tasked with fixing the relevant feature for resolution. These automatic value-based alerts inform teams that the system is experiencing issues, even if the cause of the issue is not immediately detected or apparent. This results in a smoother, more seamless experience for the individual, who are less likely to encounter technical issues or system failures. As a result, the individual exhibits higher levels of satisfaction with their devices and overall work environment.

In another implementation, if a relevant feature value relating to energy efficiency drops below a certain threshold, the system 100 sends a device automation script to the system. In some implementations, the device automation script enables a person to opt-in to an automatic device action, such as scheduling a device update at a specified time. In at least one implementation, the specified time is based on an individual device habit from the operational performance data. The scripts can be created with different parameters to fit the system to shut down at specific times. Depending on the implementation, individuals will have an option to opt-in to one of these maintenance profiles but keep the option to change/stall the script. By regularly shutting down systems, energy consumption and green-house gas emissions can be reduced. Additionally, predicting energy usage patterns based on individual work discipline can aid in optimizing energy-saving initiatives within an organization.

In yet another implementation, the system 100 uses a ML model to predict device lifespan based on the persona's device usage discipline. The system 100 is configured to proactively trigger alerts to an operations team when a relevant feature value of the persona's device, such as a reliability value, falls below a certain threshold. The system 100 can also send scripts to automatically trigger on the persona's device, which is a persona itself, to help further limit device damage. Furthermore, the device feature values can be used to make decisions on procurement of such devices in future.

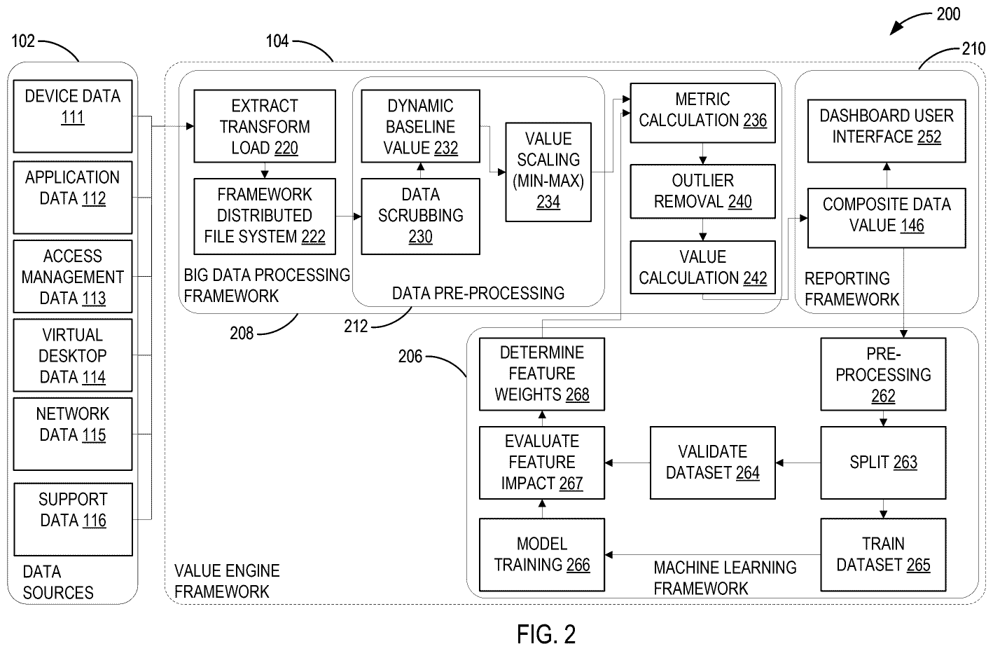

Referring to FIG. 2, a system 200 for generating and presenting a composite data value in a user interface (UI) is shown. The system 200 shares some elements of system 100 of FIG. 1, which are shown with identical reference figures. The system 200 comprises various data source 102 and a value engine framework 104. The value engine framework 104 comprises a machine-learning (ML) framework 206, a big data processing framework 208, and a reporting framework 210. The value engine framework 104 collects operational performance data from the various data sources 102, prepares it for processing, identifies relevant features in the data, generates baseline values, assigns features weights, calculates a final composite data value, presents the value in a UI, and dynamically determines feature weights based on the final composite data value.

The various data sources 102 comprise raw operational performance data. Device data 111 relates to the hardware and operating system of the device of a persona. Depending on the implementation, it includes performance data, such as a standardized benchmark value for the device, screen resolution, random-access memory, available storage, battery health, device age, connected accessories, system crash reports, power consumption, system settings, any detected hardware failures, startup applications, and/or device boot time. Application data 112 includes data relating to the applications used by the organization and the applications that the persona launches, both desktop and web applications, such as application name, file size, boot time, version number, crash reports, use time, and/or the number of apps running simultaneously. Access management data 113 relates to the scope of access allowed to the persona, such as the persona's status (e.g., an employee, a vendor, a contractor, etc.), persona permissions, persona login attempts, frequency of password changes, and/or any two-factor authentication requirements. Virtual desktop data 114 relates to the experience of personas using virtual desktops, such as experienced latency, crash reports, graphic rendering issues, connectivity issues, network bandwidth constrains, login attempts, and/or application compatibility issues. Network data 115 relates to the quality of network connectivity and the persona experience during meetings/calls, such as average network speed, network bandwidth, call bit rate, call crash reports, call issues, network latency, Wi-Fi signal strength, and/or network availability. Support data 116 relates to the persona experience with information technology (IT) support, such as support ticket information, response time, call time, support call transcriptions, support messages, and/or persona feedback.

The big data processing framework 208 receives the raw operational performance data with an extract, transform, and load (ETL) 220 process. The various experience types are organized into a framework distributed file system 222, such as the Hadoop Distributed File System. The framework distributed file system 222 allows for the efficient analysis of large data sets across multiple hardware devices. The raw operational performance data is also organized into a system that the big data processing framework 208 can understand. The organized raw operational performance data is then sent to data pre-processing 212 comprising data scrubbing 230, dynamic baseline scoring 232, and value scaling 234.

The raw operational performance data often contains duplicates, errors, omissions, improper formatting, or other issues that prevent immediate analysis. The procedure of data scrubbing 230 is a methodical approach to ensure that the information is in a suitable state for further processing. This includes the elimination of irrelevant or extraneous information, correction of any errors present, and standardization of the data format. The goal is to refine the data so that it is consistent and ready for the next stages of processing. The scrubbing process 230 may encompass a range of techniques. These can include filtering out data that does not pertain to the persona's experience, filling in or addressing missing values, normalizing data ranges for consistency, and removing any duplicate records that may skew the analysis.

The cleansed operational performance data is then processed to identify relevant features and assign a dynamic baseline value 232. In some implementations, the dynamic baseline scoring 232 can use machine learning, such as the ML process 106 in FIG. 1, to identify relevant features in the cleaned operational performance data. In other implementations, an operator can manually determine which features in the cleaned operational performance data are considered relevant features. The relevant features are then assigned a baseline value. In at least one implementation, the baseline values are based on the relevant feature data in the past thirty days.

The baseline values are then scaled using value scaling 234 to a single reference scale. The single reference scale uses the same minimum and maximum value for each baseline value. The various data types have different relative values, so scaling is necessary to accurately compare the various data types. In at least one implementation, the baseline values are assigned a value between 0-100.

In some implementations, after the baseline values are scaled, the values are assigned feature weights in a metric calculation 236. The feature weights are determined by a ML framework 206 based on other data values. The weights reflect the relative importance of the respective feature with respect to the other features. Depending on the implementation, the weights are assigned to the features (child parameters) independently of their respective categories (parent parameters) or not. The baseline values with applied weights are value metrics.

In some implementations, the outlier values are removed 240 from the final composite data value calculation after the weights are applied. In other implementations, the outlier values are removed 240 from the final value calculation prior to the application of the weights. In at least one implementation, outlier value metrics are removed using a modified Z score. This statistical method ensures that data points that are significantly different from the rest and could skew the composite data value are not included in the computation. The modified Z score is a measure of statistical deviation within a dataset and is used here to maintain the integrity of the scoring process.

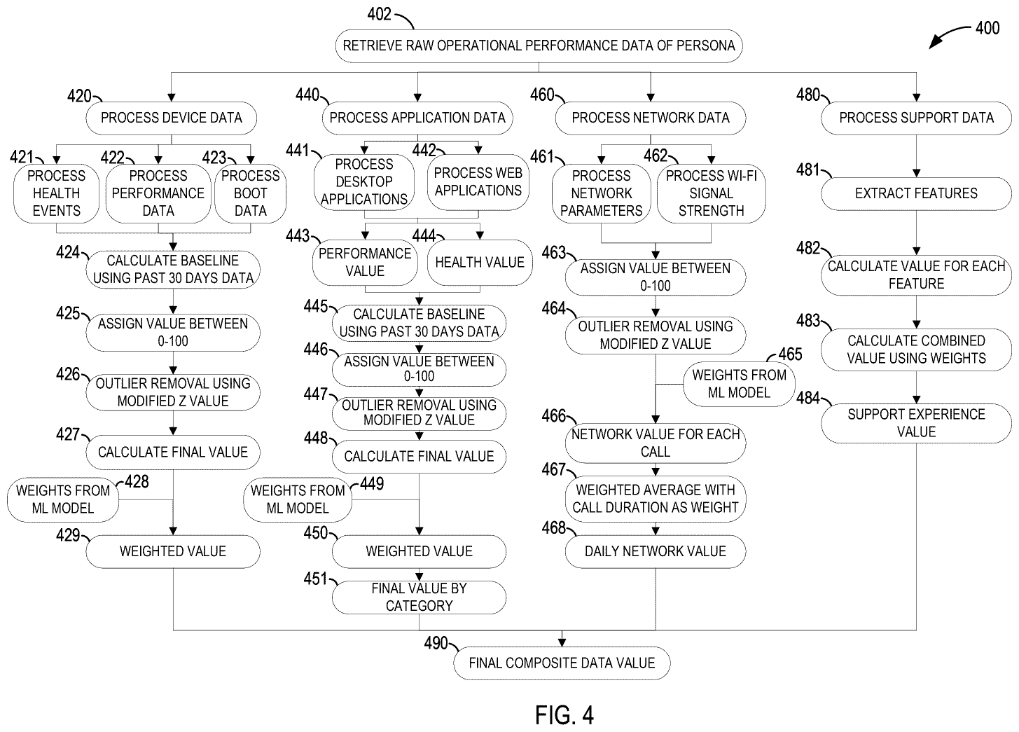

The final value calculation 242 determines the final feature and category values and aggregates all value metrics into the final composite data value 146. An alternative description of the process for generating the final composite data value 146 is shown in process 400 of FIG. 4.

The final composite data value 146 is presented as an icon in a dashboard UI 252 as part of a reporting framework 210. In some implementations, a dashboard meter is also presented in the UI 252 with the icon of the composite data value. The icon of the composite data value is automatically moved to a position in the UI 252 based on a magnitude of the composite data value. In some implementations, the final feature values and final category values are also presented in the dashboard UI 252.

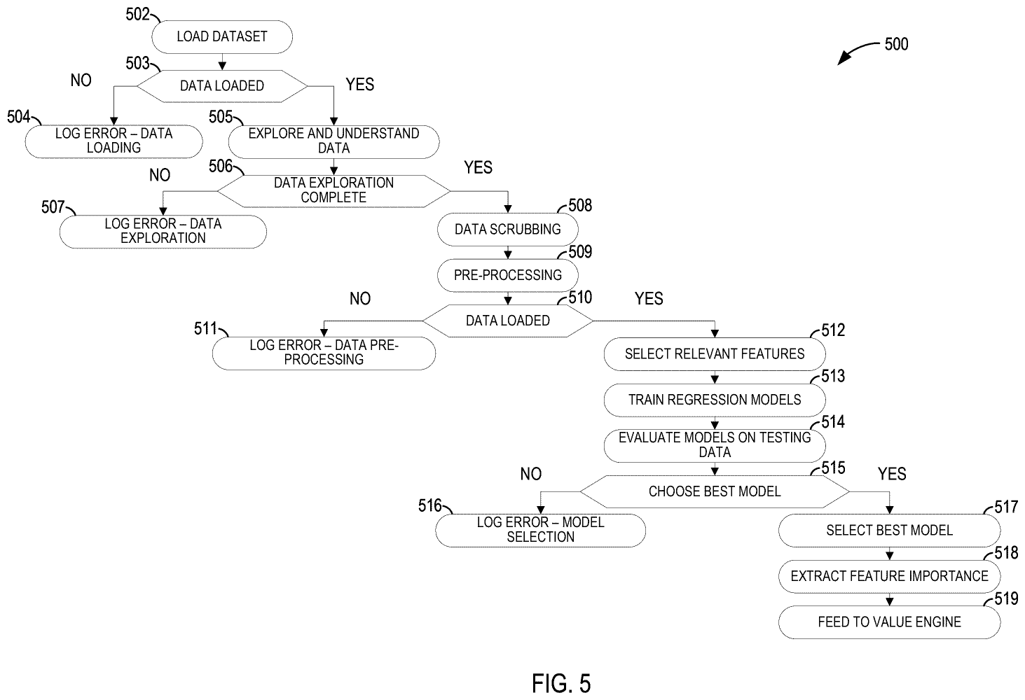

The final composite data value 146 is used to train a ML model in the ML framework 206. The ML framework 206 receives the final composite data value, as well as the values for the features and categories, for pre-processing 262. The composite data value data is split 263 so that some data is used for training the ML model and some data is used for evaluating the model. In some implementations, the data used for training the ML model is used to generate a training dataset 265 that is used for the ML model training 266. A validate dataset 264 is generated using the data for evaluating the model. The model is then trained on the training dataset 265 using ML techniques known in the art. The outputs of the model training 266 are the generated impacts of the features on the final composite data value. These feature impact outputs are evaluated 267 using the validate dataset 264 for evaluating the model. The process of generating the dataset, training the model, and evaluating the output repeats multiple times to achieve the most accurate model. Finally, the feature weights are determined 268 using the most accurate model determined from the ML framework 206. An alternative description of the ML process is shown in process 500 of FIG. 5.

In some implementations, the ML framework 206 dynamically reassigns the weights for the features (child parameters) and categories (parent parameters) at a chronological interval. The ML framework 206 reassigns the weights automatically. In at least one implementation, the chronological interval is every three months. Regularly and automatically reassigning the weights allows the model to remain accurate as new information is gathered and the underlying operational performance data sets change over time. The scheduled refresh also allows the model to account for individuals' changing preferences over time, ensuring that the model does not entrench system performance preferences from the past.

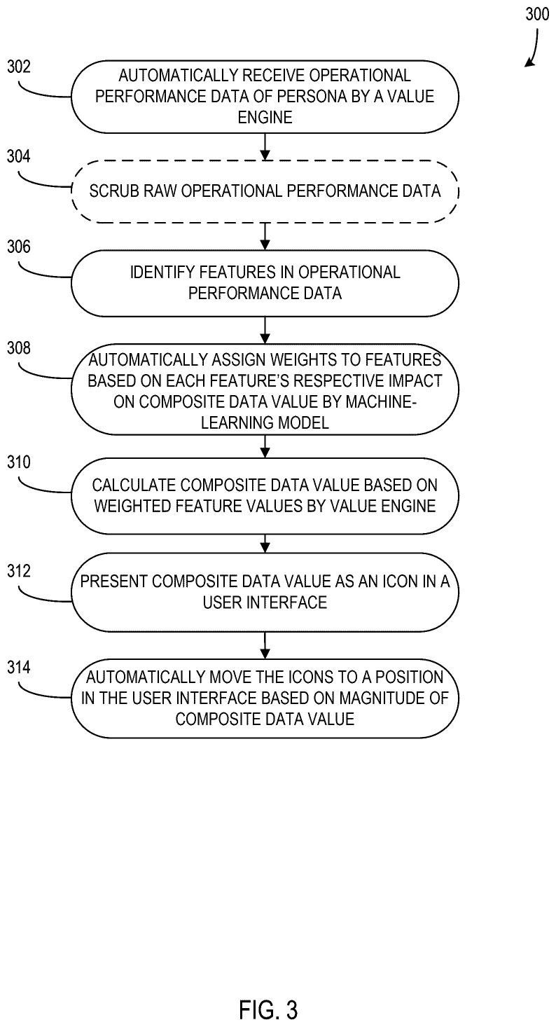

Referring to FIG. 3, a flow chart illustrates a process 300 of a computing device generating and presenting a composite data value on a user interface (UI). The process 300 can be implemented according to systems 100 and 200 of FIGS. 1 and 2 respectively.

At operation 302, a value engine of the computing device automatically receives operational performance data. The operational performance data includes application data, device data, and network data. The operational performance data is gathered automatically and does not require an individual to submit an evaluation form.

At optional operation 304, the computing device scrubs the operational performance data for analysis. Scrubbing the operational performance data removes errors and formats the data so that it can be understood by the computing device.

At operation 306, the computing device identifies features in the operational performance data. In some implementations, the identification occurs automatically using machine-learning (ML) techniques.

At operation 308, an ML model of the computing devices automatically assigns weights to the features based on each feature's respective impact on a composite data value. The composite data value is a measure of the aggregate system performance with both hardware and software technology. The composite data value includes an application, device, and network value based on the application, device, and network data respectively.

At operation 310, the value engine calculates the composite data value based on the weighted feature values of the application, device, and network values.

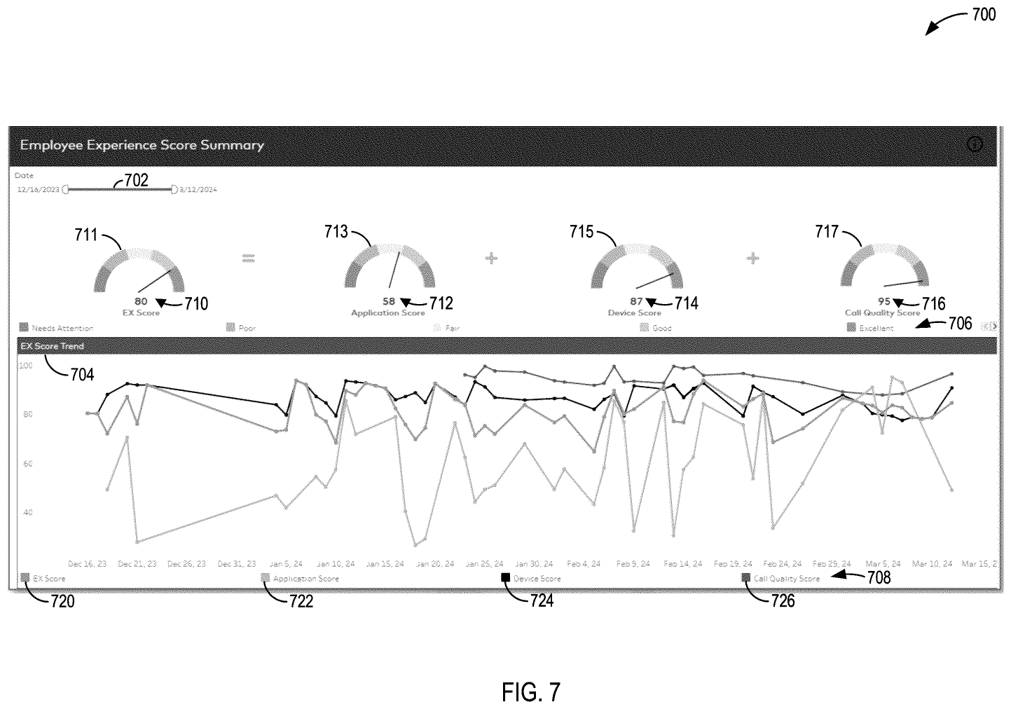

At operation 312, the computing device presents the composite data value as an icon in a UI. In some implementations, the composite data value is presented as icon 710 in FIG. 7.

Finally, at operation 314, the computing devices automatically moves the icon of the composite data value to a position in the UI based on a magnitude of the composite data value. In some implementations, the icon includes a dashboard meter and an element of the icon is overlayed on the dashboard meter to correspond to the magnitude of the composite data value.

Referring to FIG. 4, a flowchart of example process 400 to calculate a composite data value with a computing device is shown. The process 400 is implemented using a computing device storing instructions that are executed by a processor. The process 400 begins at operation 402 with retrieving raw operational performance data. The raw operational performance data is then processed by category. In the example of process 400, the raw operational performance data includes device data, application data, network data, and support data. Depending on the implementation, processing includes ETL, distribution into a file system, data scrubbing, reformatting, and feature identification.

At operations 420, 440, 460, and 480, the device, application, network, and support data of the raw operational performance data are processed respectfully. Operation 420 identifies data relating to device health events, performance data, and boot data as relevant features. Operation 440 distinguishes between two sub-categories of application data, desktop and web applications, and identifies application performance and health values as relevant features. Operation 460 identifies data relating to network parameters and Wi-Fi signal strength as relevant features.

The health events, performance data, and boot data are processed at operations 421, 422, and 423 respectfully. The desktop and web applications are processed at operations 441 and 442 respectfully and the performance and health values are processed at operations 443 and 444 respectfully. The network parameters and Wi-Fi signal strengths are proceed at operations 461 and 462 respectively. The relevant features in the support data are extracted at operation 481. The relevant features of the raw operational performance data are compared against prior relevant feature data and data values to determine a relative impact of the relevant features on a final composite data value.

At operations 424 and 445, the computing device calculates a baseline value for the relevant features of the device and application data respectfully using prior data. In the example of process 400, the baseline is an average of the operational performance data over the past 30 days.

The relevant features baseline values are then normalized to a consistent scale. At operations 425, 446, and 463 the features of the device, application, and network data respectfully are assigned a value between 0-100 to represent the relative magnitude of the impact of the features. The computing device also calculates a value for each relevant feature of the support data at operation 482.

The process 400 then removes outlier values of the device, application, and network feature values at operations 426, 447, and 464. The outlier values are removed using a modified Z score statistical calculation so that only the values within a certain statistical range are considered for the final composite data value calculation. Removing outlier values safeguards against likely erroneous values that could skew the final composite data value.

At operations 427 and 448, the computing device calculates final values for the relevant features of the device and network data respectfully. At operations 428, 449, and 465, the computing device applies weights from a ML model to the device, application, and network values respectfully. At operation 466, the computing device additionally calculates a network value for each call made over the network.

At operations 429 and 450, applying the weights from the ML model determines the weighted values for the device and application data respectfully. At operation 451, the computing device additionally determines a final weighted value for the two subcategories of the application data. At operation 467, the computing device calculates a weighted average of the network value for each call where the call duration is the weight. At operation 468, the computing device additionally calculates a daily network value. At operation 483, the computing device calculates a combined value for the relevant features of the support data using weights, resulting in the final support experience value at operation 484.

The weighted values of the device, application, network data, and the final support experience value are aggregated at operation 490 to produce the final composite data value. Process 400 ends with operation 490.

Referring to FIG. 5, a flowchart illustrating an example process 500 to determine weights to relevant features using machine learning on a computing device is shown. Process 500 begins with loading data in operation 502. Loading data can include retrieving operational performance data from various data sources as described above. At operation 503, the computing device assesses whether there were any errors during data loading. If any errors occurred, the computing device generates a log error-data loading at operation 504, and the process ends.

If no errors occur, then the computing device explores and understands the data at operation 505. At operation 506, the computing device assesses whether there were any errors during data exploration. If any errors occurred, then the computing device generates a log error-data exploration at operation 507, and the process ends.

If no errors occur, then the computing device scrubs the data at operation 508. Data scrubbing includes data reformatting and error removal as described above. At operation 509, the computing device performs data pre-processing. Data pre-processing organizes the scrubbed data into a machine-readable form. At operation 510, the computing device assesses whether there were any errors during data pre-processing. If any errors occurred, then the computing device generates a log error-data pre-processing at operation 511, and the process ends.

If no errors occurred, then the computing device selects relevant features from the data at operation 512. In some implementations, the computing device uses machine learning to identity which features are relevant from the data. Relevance is based on the impact that feature has on a final composite data value.

At operation 513, the computing device trains models on training data to determine feature impact on a final composite data value. Training involves using ML training techniques known in the art depending on the implementation, such as the use of random decision forests or splitting operational performance data into training and testing sets as shown in FIG. 2. Splitting the operational performance data into training and testing sets helps to prevent a linear regression model from overweighting unimportant variables.

At operation 514, the computing device evaluates the trained models on testing data. Testing involves using ML evaluating techniques known in the art depending on the implementation. In some implementations, evaluating the trained models involves rotating the training and testing data sets to evaluate the trained model on different data within the operational performance data. At operation 515 the computing device assesses the best model based on model evaluation at operation 514. If any errors occurred, such as no model achieving a pre-determined accuracy threshold, then the computing device generates a log error-model selection at operation 516, and the process ends. For example, models that are overfitted or underfitted are inaccurate for data points unseen in training or generate poor results that lead to inaccurate results respectively.

If no errors occur, then the computing device selects the best model at operation 517. Using the selected model, the computing device extracts the feature importance from the operational performance data at operation 518. In some implementations, operation 518 occurs with a different set of operational performance data than the model was trained on at operation 513. In at least one implementation, the extracted feature importance is a feature weight representing the feature's impact on a final composite data value. At operation 519, the computing device feeds the feature importance to a value engine for calculating a final composite data value, such as the big data processing framework 208 of FIG. 2, and the process ends.

Referring to FIG. 6, a diagram illustrating an example system 600 to assign weights to features on a computing device is shown. Depending on the implementation, system 600 is used with the other systems and methods described herein.

A scoring algorithm 603 receives operational performance data 602 for assigning weights to features in the operational performance data. In some implementations, the scoring algorithm 603 is a machine-learning model, such as the machine-learning model of process 500 in FIG. 5, that is trained to assign weights to features based on the feature's impact on a final composite data value.

The scoring algorithm 603 assigns weights to child parameters 611, 612, 621, 622, 631, and 632. The child parameters are the features in the operational performance data. The scoring algorithm 603 assigns the weights based on the child parameters' impact on a final composite data value.

In some implementations, a value of a child parameter, the weight assigned to a child parameter, or the product of both determines whether the feature is relevant to the final composite data value. In at least one implementation, if the weight is zero, then the feature is irrelevant. In additional implementations, the computing device compares the value of a child parameter, the weight assigned to a child parameter, or the product of both to a relevance threshold value. If the parameter value is below the threshold value, then the feature is considered irrelevant and excluded from the final composite data value calculation.

The weighted child parameters are aggregated into a parent parameter depending on a category of the feature. In at least one implementation, the child parameters 611 and 612 are aggregated in parent parameter 610, the child parameters 621 and 622 are aggregated in parent parameter 620, and the child parameters 631 and 632 are aggregated in parent parameter 630. In some implementations, the parent parameters 610, 620, and 630 represent categories of features, such as application features, device features, or network features.

In some implementations, the parent parameters 610, 620, and 630 are sent to a value engine 640 for calculating the final composite data value. In at least one implementation, the value engine 640 is implemented as value engine 108 in FIG. 1.

Referring to FIG. 7, an example user interface (UI) 700 displaying a composite data value icon is shown. The UI 700 is presented on a display by a computing device. Depending on the implementation, UI 700 is used with the other systems and methods described herein.

UI 700 displays an icon 710 that represents a composite data value. As shown in the example of UI 700, the composite data value represents a digital experience score of a persona. In some implementations, the icon 710 includes words, numbers, and/or graphical elements, such as a line. In at least one implementation, the icon 710 includes a number representing the digital experience score of the persona.

In some implementations, the icon 710 includes a dashboard meter 711 that includes markings that provide magnitude information. In some versions, the dashboard meter 711 is arc shaped. In at least one implementation, the dashboard meter 711 is a semicircle. Additionally, some implementations include a dashboard meter legend 706 that describes the magnitude information on the dashboard meter. In at least one implementation, dashboard meter legend 706 includes a label for each color band on the dashboard meter 711.

The computing device automatically moves the icon 710 of the experience score to a position on the UI 700 based on the magnitude of the experience score. The magnitude for each icon is automatically determined by the computing device when it calculates an experience score for a persona. In some implementations, the icon 710 is moved to position on the dashboard meter 711 corresponding to the magnitude of the experience score. In at least one implementation, a shape of the icon 710, such as a line, is moved to the position on the dashboard meter 711 while a number and/or text of the icon 710 are presented beneath the shape. Overlaying the icon 710 on the dashboard meter 711 provides an intuitive understanding of the magnitude of the digital experience score. A dashboard meter of a vehicle is a familiar gauge to many users so using the dashboard meter as a reference scale to the digital experience score gives a user context to the magnitude of the digital experience score of the persona.

The UI 700 additionally presents icons 712, 714, and 716 representing an application, device, and network score of a persona respectively. In some implementations, the icons 712, 714, and 716 include dashboard meters 713, 715, and 717. The icons 712, 714, and 716 are automatically moved to represent the magnitude of the application, device, and network scores respectively. Depending on the implementation, the UI 700 presents additional or fewer icons with optional dashboard meters depending on the categories of features that make up the digital experience score. The additional icons 712, 714, and 716 with dashboard meters 713, 715, and 717 provide additional context to the user for the magnitude of the digital experience score. The feature category scores are aggregated to arrive at the digital experience score. Including the component scores of the digital experience score provides additional insight to the user while maintaining the advantages of automatically moving icons to a position on a dashboard meter.

In several versions, the UI 700 includes an experience score graph 704. The experience score graph 704 includes a reference scale of the digital experience score magnitude and a scale of time increments. The experience score graph 704 plots experience score values 720 over time, such as in a line graph. In some versions, the experience score graph 704 additionally plots application 722, device 724, and network 726 score values over time. Plotting the score values over time provides additional insight to the user in an easy to understand and intuitive way similar to the dashboard meters. In at least one version, the digital experience score graph includes a graph legend 708 that identifies any plotted score values with a label description.

In some implementations, the UI 700 includes a time range icon 702. The time range icon 702 enables the user to select the time range of score values shown on the UI 700. The score values plotted on the experience score graph 704 are limited to the time range that the user selects. In at least one implementation, the most recent time on the time range icon 702 represents the most recent experience score icon 710 from that time. In another implementation, the experience score icon 710 is the average value of data values in the selected time range.

In at least one implementation, the UI 700 presents an average composite data value for a plurality of personas. The user is able to select groupings of personas by various organizational parameters (such as geographic region, business unit, technology hub, job family group, etc.). The UI 700 updates the digital experience score icon 710, any other category score icons, and the experience score graph 704 based on the selected persona groupings. Averaging the composite data values across a plurality of personas enables the user to quickly gain insights into trends across different parts of an organization, which can assist the user in spotting issues.

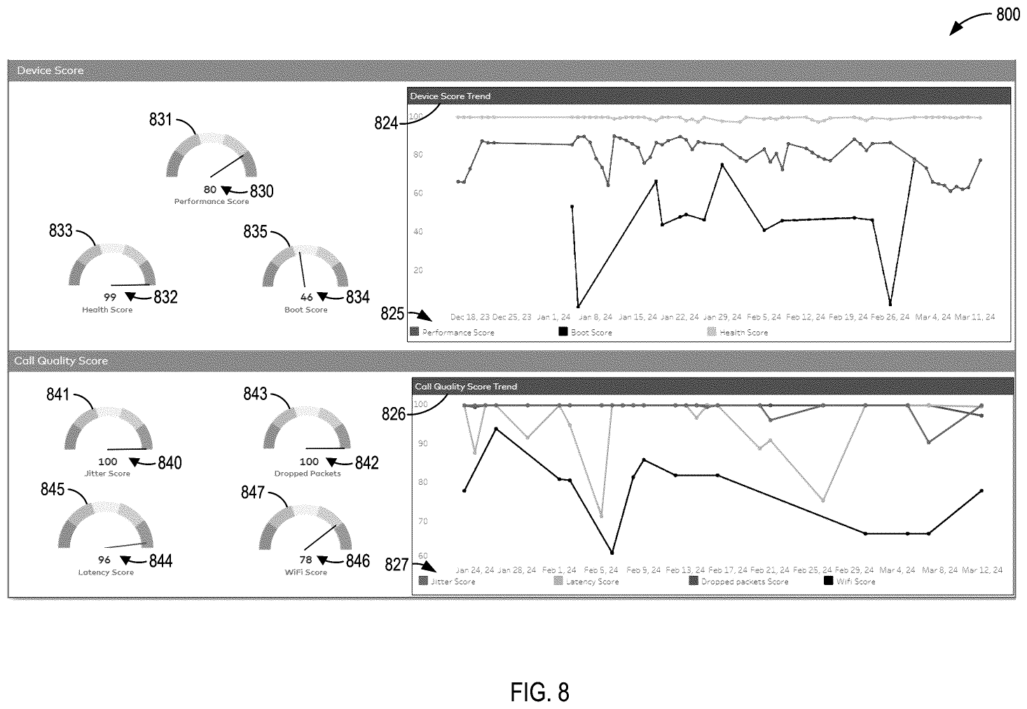

Referring to FIG. 8, an example user interface (UI) 800 displaying components of a composite data value on dashboard meters is shown. The UI 800 is presented on a display by a computing device. Depending on the implementation, UI 800 is used with the other systems and methods described herein.

In some implementations, the components of the composite data value are scores for categories of features, such as an application score, device score, and/or network score. These category scores are comprised of individual feature scores, such as a performance, health, and/or boot score for a device category. Depending on the implementation, the individual feature scores are displayed as icons in the UI 800 and moved to a position on corresponding dashboard meters representing the scores' magnitude. Visually representing feature scores provides a user with even further insight into the reasoning behind the category scores and ultimately the aggregated composite data value as well.

Feature scores of corresponding categories are displayed as icons in the UI 800. In some versions, the UI 800 presents icons 830, 832, and 834 representing a performance, health, and booth score respectively of a persona's device. In some implementations, the icons 830, 832, and 834 include dashboard meters 831, 833, and 835 to which the icons 830, 832, and 834 are automatically moved to represent the magnitude of the performance, health, and boot scores respectively. In additional versions, the UI 800 presents icons 840, 842, 844, and 846 representing a jitter, dropped packets, latency, and Wi-Fi score respectively of a persona's network. In at least one version, the icons 840, 842, 844, and 846 include dashboard meters 841, 843, 845, and 847 to which the icons 840, 842, 844, and 846 are automatically moved to represent the magnitude of the jitter, dropped packets, latency, and Wi-Fi scores respectively.

In some implementations, the UI 800 presents a category graph that plots feature scores of a corresponding category over time, such as in a line graph. The category graph includes a reference scale of the category score magnitude and a scale of time increments. In at least one implementation, the UI 800 presents a device category graph 824 and a network category graph 826. The device category graph 824 includes a device graph legend 825 and plots performance, boot, and health score values over time. The network category graph 826 includes a network graph legend 827 and plots jitter, dropped packets, latency, and Wi-Fi scores over time. The graph legends identify any plotted score values with a label description.

If a user selects a time range with the time range icon 702 of FIG. 7, then UI 800 updates the feature score icons and positions based on the selected time range. The UI 800 also updates the category graphs to display the plotted feature score values within the selected time range.

### Exemplary Operating Environment

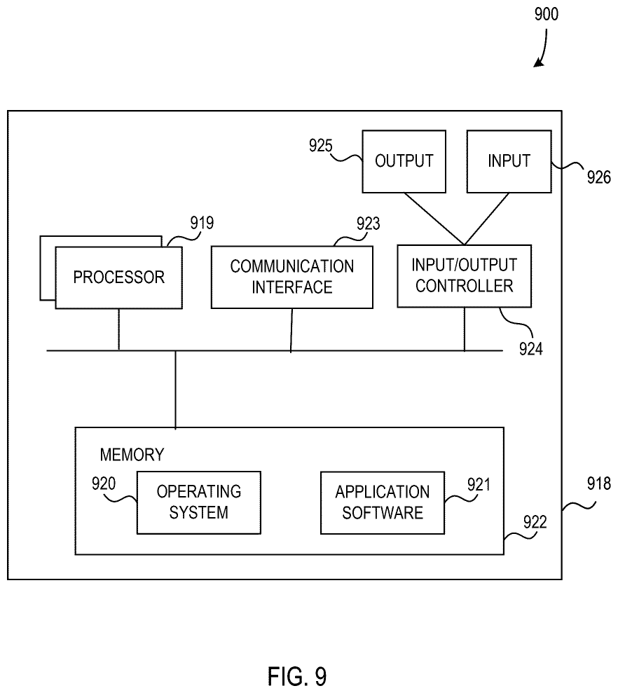

The present disclosure is operable with a computing apparatus according to an implementation as a functional block diagram of a computing system 900 in FIG. 9. In an implementation, components of a computing apparatus 918 may be implemented as a part of an electronic device according to one or more embodiments described in this specification. The computing apparatus 918 comprises one or more processors 919 which may be microprocessors, controllers, or any other suitable type of processors for processing computer executable instructions to control the operation of the electronic device. Alternatively, or in addition, the processor 919 is any technology capable of executing logic or instructions, such as a hardcoded machine. Platform software comprising an operating system 920 or any other suitable platform software may be provided on the apparatus 918 to enable application software 921 to be executed on the device.

Computer executable instructions may be provided using any computer-readable media that are accessible by the computing apparatus 918. Computer-readable media may include, for example, computer storage media such as a memory 922 and communications media. Computer storage media, such as the memory 922, include volatile and non-volatile, removable, and non-removable media implemented in any method or technology for storage of information such as computer readable instructions, data structures, program modules or the like. Computer storage media include, but are not limited to, RAM, ROM, EPROM, EEPROM, persistent memory, phase change memory, flash memory or other memory technology, CD-ROM, digital versatile disks (DVD) or other optical storage, magnetic cassettes, magnetic tape, magnetic disk storage, shingled disk storage or other magnetic storage devices, or any other non-transmission medium that can be used to store information for access by a computing apparatus.

In contrast, communication media embody computer readable instructions, data structures, program modules, or the like in a modulated data signal, such as a carrier wave, or other transport mechanism. As defined herein, computer storage media do not include communication media. Therefore, a computer storage medium does not include a propagating signal. Propagated signals are not examples of computer storage media. Although the computer storage medium (the memory 922) is shown within the computing apparatus 918, it will be appreciated by a person skilled in the art that the storage may be distributed or located remotely and accessed via a network or other communication link (e.g., using a communication interface 923).

The computing apparatus 918 may comprise an input/output controller 924 configured to output information to one or more output devices 925, for example a display or a speaker, which may be separate from or integral to the electronic device. The input/output controller 924 may also be configured to receive and process an input from one or more input devices 926, for example, a keyboard, a microphone, or a touchpad. In one implementation, the output device 925 may also act as the input device. An example of such a device may be a touch sensitive display. The input/output controller 924 may also output data to devices other than the output device, e.g., a locally connected printing device. In some embodiments, a user may provide input to the input device(s) 926 and/or receive output from the output device(s) 925.

The functionality described herein can be performed, at least in part, by one or more hardware logic components. According to an implementation, the computing apparatus 918 is configured by the program code when executed by the processor 919 to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), Graphics Processing Units (GPUs).

At least a portion of the functionality of the various elements in the figures may be performed by other elements in the figures, or an entity (e.g., processor, web service, server, application program, computing device, etc.) not shown in the figures.

Although described in connection with an exemplary computing system environment, examples of the disclosure are capable of implementation with numerous other general purpose or special purpose computing system environments, configurations, or devices.

Examples of well-known computing systems, environments, and/or configurations that may be suitable for use with aspects of the disclosure include, but are not limited to, mobile or portable computing devices (e.g., smartphones), personal computers, server computers, hand-held (e.g., tablet) or laptop devices, multiprocessor systems, gaming consoles or controllers, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. In general, the disclosure is operable with any device with processing capability such that it can execute instructions such as those described herein. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions, or the specific components or modules illustrated in the figures and described herein. Other examples of the disclosure may include different computer-executable instructions or components having more or less functionality than illustrated and described herein.

In examples involving a general-purpose computer, aspects of the disclosure transform the general-purpose computer into a special-purpose computing device when configured to execute the instructions described herein.

An example system for calculating a composite data value for a user comprises a processor and a computer-readable medium storing instructions. The instructions are operative upon execution by the processor to: automatically receive, by a value engine, operational performance data of a user, wherein the operational performance data comprises application data, device data, and network data; identify a plurality of features in the operational performance data; automatically assign weights, by a machine-learning model, to the plurality of features based on each feature's respective impact on a composite data value, wherein the composite data value comprises an application, device, and network score based on the application, device, and network data respectively; calculate the composite data value, by the value engine, based on the weighted features of the application, device, and network scores; present the composite data value as an icon in a user interface; and automatically move the icon of the composite data value to a position in the user interface based on a magnitude of the composite data value.

An example computerized method comprises automatically receiving, by a value engine, operational performance data of a user, wherein the operational performance data comprises application data, device data, and network data; identifying a plurality of features in the operational performance data; automatically assigning weights, by a machine-learning model, to the features based on each feature's respective impact on a composite data value, wherein the composite data value comprises an application, device, and network score based on the application, device, and network data respectively; calculating the composite data value, by the value engine, for the user based on the weighted features of the application, device, and network scores; presenting the composite data value as an icon in a user interface; and automatically moving the icon of the composite data value to a position in the user interface based on a magnitude of the composite data value.

An example computer storage medium has computer-executable instructions that, upon execution by a processor, cause the processor to at least: automatically receive, by a value engine, operational performance data of a user, wherein the operational performance data comprises application data, device data, and network data; scrub the operational performance data for analysis; identify a plurality of features in the operational performance data; automatically assign weights, by a machine-learning model, to the plurality of features based on each feature's respective impact on a composite data value, wherein the composite data value comprises an application, device, and network score based on the application, device, and network data respectively; calculate the composite data value, by the value engine, for the user based on the weighted features of the application, device, and network scores; present the composite data value as an icon in a user interface; and automatically move the icon of the composite data value to a position in the user interface based on a magnitude of the composite data value.

Alternatively, or in addition to the other examples described herein, examples include any combination of the following:
instructions that are further operative to train the machine-learning model with a training dataset based on the composite data value.
instructions that are further operative to dynamically reassign the weights, by the machine-learning model, at a chronologic interval.
instructions that are further operative to remove an outlier feature from the composite data value calculation based on a modified Z score.
wherein the operational performance data of the user further comprises access data, and wherein the composite data value further comprises an access score based on the access data.
wherein the operational performance data of the user further comprises information technology (IT) support data, and wherein the composite data value further comprises an IT support score based on the IT support data.
instructions that are further operative to present a device automation script to the user that enables the user to opt-in to automatic device actions.
wherein the automatic device action is scheduling a device update at a specified time,
wherein the specified time is based on a user device habit from the operational performance data of the user.
wherein the operational performance data is experience data of a persona.
wherein the composite data value is a digital experience score for a persona.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It is understood that the benefits and advantages described above may relate to one implementation or may relate to several implementations. The embodiments are not limited to those that solve any or all of the stated problems or those that have any or all of the stated benefits and advantages. It will further be understood that reference to ‘an’ item refers to one or more of those items.

The term “comprising” is used in this specification to mean including the feature(s) or act(s) followed thereafter, without excluding the presence of one or more additional features or acts.

In some examples, the operations illustrated in the figures may be implemented as software instructions encoded on a computer readable medium, in hardware programmed or designed to perform the operations, or both. For example, aspects of the disclosure may be implemented as a system on a chip or other circuitry including a plurality of interconnected, electrically conductive elements.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system for calculating a composite data value representing aggregated system performance, the system comprising:
a processor; and
a computer-readable medium storing instructions that are operative upon execution by the processor to:
automatically receive, by a data processing engine, operational performance data from a plurality of database sources, wherein the operational performance data comprises application performance data, device performance data, and network performance data;
identify a plurality of data correlation patterns within the operational performance data across the plurality of database sources;
automatically calculate weighting coefficients, by a computational analysis module, for the plurality of data correlation patterns based on each pattern's respective contribution to system performance metrics, wherein the system performance metrics comprise application performance values, device performance values, and network performance values derived from the application, device, and network performance data respectively;
calculate a composite data value, by the data processing engine, representing aggregated system performance based on the weighted data correction patterns from the application, device, and network performance values;
render the composite data value as a graphical interface element in a user interface (UI); and
automatically position the graphical interface element at a calculated location within the UI based on a numerical magnitude of the composite data value.

2. The system of claim 1, storing instructions that are further operative to:
train the computational analysis module with a training dataset based on the composite data value.

3. The system of claim 2, storing instructions that are further operative to:
dynamically recalculate weighting coefficients, by the computational analysis module, at a chronologic interval.

4. The system of claim 1, storing instructions that are further operative to:
remove an outlier data correction pattern from the composite data value calculation based on a modified Z score.

5. The system of claim 1,
wherein the operational performance data further comprises access data, and wherein the composite data value further comprises an access value based on the access data.

6. The system of claim 1,
wherein the operational performance data further comprises information technology (IT) support data, and
wherein the composite data value further comprises an IT support value based on the IT support data.

7. The system of claim 1, storing instructions that are further operative to:
present a device automation script to a persona that enables the persona to opt-in to an automatic device action.

8. The system of claim 7, wherein the automatic device action schedules an automatic device update at a specified time, wherein the specified time is based on a persona device habit from the operational performance data of the persona.

9. A computerized method comprising:
automatically receiving, by a data processing engine, operational performance data from a plurality of database sources, wherein the operational performance data comprises application performance data, device performance data, and network performance data across the plurality of database sources;
identifying a plurality of data correlation patterns within the operational performance data across the plurality of database sources;
automatically assigning weights, by a computational analysis module, to the plurality of data correlation patterns based on each pattern's respective contribution to system performance metrics, wherein the system performance metrics comprise application performance values, device performance values, and network performance values derived from the application, device, and network performance data respectively;
calculating a composite data value, by the data processing engine, based on the weighted data correlation patterns of the application, device, and network performance values;
presenting the composite data value as an icon in a user interface (UI); and
automatically moving the icon of the composite data value to a position in the UI based on a magnitude of the composite data value.

10. The method of claim 9, further comprising:
training the computational analysis module with a training dataset based on the composite data value.

11. The method of claim 10, further comprising:
dynamically reassigning the weights, by the computational analysis module, at a chronologic interval.

12. The method of claim 9, further comprising:
removing an outlier data correction pattern from the composite data value calculation based on a modified Z score.

13. The method of claim 9,
wherein the operational performance data further comprises access data, and
wherein the composite data value further comprises an access value based on the access data.

14. The method of claim 9,
wherein the operational performance data further comprises information technology (IT) support data, and
wherein the composite data value further comprises an IT support value based on the IT support data.

15. A computer storage medium having computer-executable instructions that, upon execution by a processor, cause the processor to at least:
automatically receive, by a value engine, operational performance data, wherein the operational performance data comprises application data, device data, and network data;
identify a plurality of features in the operational performance data;
automatically assign weights, by a machine-learning model, to the plurality of features based on each feature's respective impact on a composite data value, wherein the composite data value comprises an application, device, and network value based on the application, device, and network data respectively;
calculate the composite data value, by the value engine, based on the weighted features of the application, device, and network values;
present the composite data value as an icon in a user interface (UI); and
automatically move the icon of the composite data value to a position in the UI based on a magnitude of the composite data value.

16. The computer storage medium of claim 15, having instructions that further cause the processor to at least:
train the machine-learning model with a training dataset based on the composite data value.

17. The computer storage medium of claim 16, having instructions that further cause the processor to at least:
dynamically reassign the weights, by the machine-learning model, at a chronologic interval.

18. The computer storage medium of claim 15, having instructions that further cause the processor to at least:
remove an outlier feature from the composite data value calculation based on a modified Z score.

19. The computer storage medium of claim 15,
wherein the operational performance data further comprises access data, and
wherein the composite data value further comprises an access value based on the access data.

20. The computer storage medium of claim 15,
wherein the operational performance data further comprises information technology (IT) support data, and
wherein the composite data value further comprises an IT support value based on the IT support data.
